(19) United States
(12) Patent Application Publication
(10) Pub. No.: US 2025/0205973 A1
(43) Pub. Date: Jun. 26, 2025

(54) AUTOMATED ULTRASONIC WELDING STATIONS AND RELATED METHODS

(71) Applicant: ATS CORPORATION, Cambridge (CA)

(72) Inventors: Kenneth Wayne NICHOLSON, Smiths Falls (CA); Philip David MUNROE, Kingston (CA)

(21) Appl. No.: 19/073,167

(22) Filed: Mar. 7, 2025

Related U.S. Application Data
(63) Continuation of application No. PCT/CA2023/051191, filed on Sep. 8, 2023.
(60) Provisional application No. 63/492,840, filed on Mar. 29, 2023.
(60) Provisional application No. 63/405,137, filed on Sep. 9, 2022.

(51) Int. Cl. B29C 65/78; B29C 65/00; B29C 65/08

(52) U.S. Cl. CPC B29C 65/7802; B29C 65/08; B29C 65/787; B29C 66/961

(57) ABSTRACT

A method of ultrasonic welding in an automated mass production process includes: (a) advancing a pallet to move a set of workpieces in the pallet into alignment with a lift of an ultrasonic welding station; (b) operating the lift to raise the set of workpieces out from the pallet and into contact with a horn of the ultrasonic welding station; (c) when the set of workpieces are in contact with the horn, transmitting vibrational energy from the horn to the set of workpieces to weld the workpieces together in a welding operation; and (d), after (c), operating the lift to lower the set of workpieces out of contact with the horn and back into the pallet.

### CROSS-REFERENCE TO RELATED APPLICATIONS

This application is a continuation of PCT/CA2023/051191, filed Sep. 8, 2023, which claims the benefit of U.S. Provisional Application No. 63/405,137, filed Sep. 9, 2022, and U.S. Provisional Application No. 63/492,840, filed Mar. 29, 2023, each of which is hereby incorporated herein in its entirety.

### FIELD

The present disclosure relates to methods and systems for ultrasonic welding in automated mass production processes.

### INTRODUCTION

U.S. Pat. No. 9,904,281 (Nicholson et al.) discloses an automated method of assembling or processing components using computer numerical controlled drives to decouple the stages of delivering components to a tool, into a series of separately programmable stages, namely, a component loading stage, a component separating stage, an accelerating stage, and a delivery stage, wherein the timing, position, speed, velocity, and acceleration of each component during each stage is selected through programming of the computer numerical controls.

U.S. Pat. No. 10,018,985 (Nicholson et al.) discloses a device, system and method of automated manufacture comprising: delivering a workpiece with a delivery device; receiving the workpiece with a receiving device, the delivering of the workpiece and the receiving of the workpiece being electronically synchronized; processing the workpiece with a processing tool while the workpiece is on the receiving device; transferring the workpiece to a completion device, the ejection of the workpiece and the transferring of the workpiece being electronically synchronized. In particular the workpiece may comprise: a platform with mounts supporting a first component in a selected orientation; and a locating surface, the method comprising: engaging and disengaging the locating surface of the workpiece with releasable connectors on the delivery device, on the receiving device and on the completion device.

Automated mass production of ultrasonically welded parts can require time to conduct each process step independently, increasing the overall cycle time required to bring an ultrasonic stack (e.g. sonotrode comprising a horn) into contact with the parts for welding, activate (energize) the ultrasonic stack, conduct the welding operation, de-activate (de-energize) the ultrasonic stack, and move the ultrasonic stack out of contact with the welded parts. A solution is desired to ultrasonically weld parts in an efficient and seamless manner through complete automation and electronic synchronization. A process is further desired to determine potential defective ultrasonic welds manufactured through the automated production.

### SUMMARY

The following summary is intended to introduce the reader to various aspects of the applicant's teaching, but not to define any invention.

According to some aspects, a method of ultrasonic welding in an automated mass production process includes: (a) advancing a pallet to move a set of workpieces in the pallet into alignment with a lift of an ultrasonic welding station, (b) operating the lift to raise the set of workpieces out from the pallet and into contact with the horn, (c) when the set of workpieces are in contact with the horn, transmitting vibrational energy from the horn to the set of workpieces to weld the workpieces together in a welding operation, and (d) after (c), operating the lift to lower the set of workpieces out of contact with the horn and back into the pallet.

In some examples, the set of workpieces are nested in a floating nest held by the pallet, and wherein (b) includes raising the lift to engage and raise the nest out from the pallet and toward the horn, and (d) includes lowering the lift to lower the nest back into the pallet and disengage the nest.

In some examples, during (b), the horn is energized to generate the vibrational energy prior to contact with the set of workpieces.

In some examples, the method further includes, during (b), increasing the vibrational energy prior to contact of the horn with the set of workpieces.

In some examples, the method further includes, during (c), increasing the vibrational energy.

In some examples, during (d), the horn remains energized while the set of workpieces is lowered out of contact with the horn.

In some examples, the method further includes, after the set of workpieces are lowered out of contact with the horn, decreasing energization of the horn. In some examples, the horn is de-energized after the set of workpieces are lowered out of contact with the horn, and re-energized prior to contact with a subsequent set of workpieces.

In some examples, energization of the horn is initiated while the horn is in contact with the set of workpieces to initiate the welding operation. In some examples, after (c) and prior to (d), the horn is de-energized while in contact with the set of workpieces to terminate the welding operation.

In some examples, the method further includes, during (c), continuously: (i) monitoring a plurality of weld parameters, each weld parameter indicative of welding progress, and (ii) determining whether each weld parameter satisfies a respective termination threshold indicative of a completed weld formed between the workpieces.

In some examples, the method further includes, in response to determining that any one of the weld parameters satisfies a respective termination threshold prior to any other one of the weld parameters, initiating termination of the welding operation.

In some examples, initiating termination of the welding operation comprises one of: de-energizing the horn and lowering the set of workpieces out of contact with the horn.

In some examples, one of the weld parameters corresponds to a welding time elapsed after initiation of the welding operation and another one of the weld parameters corresponds to a weld collapse distance between the workpieces.

In some examples, the pallet holds at least a first set of workpieces and a second set of workpieces, and the method includes, after performing (a) to (d) for the first set of workpieces, repeating (a) to (d) for the second set of workpieces in a continuous process.

In some examples, the method further includes, after (d) for the second set of workpieces, advancing the pallet away from the ultrasonic welding station for further processing of the first and second sets of workpieces, and advancing another pallet to position another set of workpieces for welding at the ultrasonic welding station.

According to some aspects, an automated mass production system for ultrasonic welding of workpieces includes: (a) a plurality of pallets movably mounted to a track, each pallet carrying one or more sets of workpieces, each set of workpieces advanceable to a stop position along the track through movement of the pallet along the track, (b) an ultrasonic welding station adjacent the stop position, the ultrasonic welding station including a horn and a lift below the horn in alignment with the stop position, the lift vertically movable relative to the horn from a lowered position to a raised position for raising the set of workpieces at the stop position from the pallet and into contact with the horn, and from the raised position back to the lowered position for lowering the set of workpieces out of contact with the horn and back into the pallet, and (c) a control system configured to: (i) advance an initial pallet of the plurality of pallets along the track to move a respective set of workpieces in the pallet to the stop position, (ii) operate the lift to raise the set of workpieces at the stop position out from the pallet and into contact with the horn, (iii) when the set of workpieces are in contact with the horn, transmit vibrational energy from the horn to the set of workpieces to weld the workpieces together in a welding operation, (iv) after (iii), operate the lift to lower the set of workpieces out of contact with the horn and back into the pallet, and (v) after performing (i) to (iv) for each set of workpieces in the pallet, advancing the pallet along the track away from the ultrasonic welding station for further processing and repeating (i) to (v) for a subsequent pallet of the plurality of pallets.

In some examples, each set of workpieces is nested in a respective floating nest held by the pallet, and the control system is configured to operate the lift to engage and raise the nest out from the pallet and toward the horn for (ii), and to lower the nest back into the pallet and disengage the nest for (iv).

In some examples, the control system is configured to energize the horn during (ii) to generate the vibrational energy prior to contact with the set of workpieces.

In some examples, the control system is configured to lower the set of workpieces out of contact with the horn while the horn remains energized.

In some examples, the control system is configured to, during (iii), continuously: monitor a plurality of weld parameters, each weld parameter indicative of welding progress, and determine whether each weld parameter satisfies a respective termination threshold indicative of a completed weld formed between the workpieces.

In some examples, the control system is configured to, in response to determining that any one of the weld parameters satisfies a respective termination threshold prior to any other one of the weld parameters, initiate termination of the welding operation.

According to some aspects, a method of ultrasonic welding includes: (a) welding together a set of workpieces by transmitting vibrational energy from a horn to the set of workpieces, (b) during the welding, continuously (i) monitoring a plurality of weld parameters, each weld parameter indicative of welding progress, and (ii) determining whether each weld parameter satisfies a respective termination threshold indicative of a completed weld formed between the workpieces, and (c) in response to determining that any one of the weld parameters satisfies a respective termination threshold prior to any other one of the weld parameters, initiating termination of the welding.

In some examples, one of the weld parameters corresponds to a welding time elapsed after initiation of the welding.

In some examples, one of the weld parameters corresponds to a weld collapse distance between the workpieces.

In some examples, one of the weld parameters corresponds to a contact force between the horn and the set of workpieces.

In some examples, one of the weld parameters corresponds to a welding time elapsed after initiation of the welding and another one of the weld parameters corresponds to a weld collapse distance between the workpieces.

In some examples, another one of the weld parameters corresponds to a contact force between the horn and the set of workpieces.

In some examples, initiating termination of the welding comprises de-energizing of the horn.

In some examples, initiating termination of the welding comprises moving the set of workpieces out of contact with the horn.

In some examples, the method further includes repeating (a) to (c) for each of a plurality of welding cycles in a continuous, automated mass production process to weld together an identical set of workpieces in each welding cycle.

In some examples, in at least some of the welding cycles, termination is initiated based on a first one of the weld parameters satisfying a respective first termination threshold prior to a second one of the weld parameters satisfying a respective second termination threshold, and in at least some other welding cycles, termination is initiated based on the second one of the weld parameters satisfying the respective second termination threshold prior to the first one of the weld parameters satisfying the respective first termination threshold.

According to some aspects, an ultrasonic welding station for an automated mass production system includes: (a) a horn for transmitting vibrational energy for ultrasonic welding, (b) an actuator system operable to move a set of workpieces and the horn relative to each other for bringing the horn and the set of workpieces into and out of contact with each other, and (c) a control system configured to: (i) operate the actuator system to bring the horn and the set of workpieces into contact with each other, (ii) when the set of workpieces are in contact with the horn, transmit the vibrational energy to the set of workpieces through the horn to weld the workpieces together in a welding operation, (iii) during the welding operation, continuously monitor a plurality of weld parameters, each weld parameter indicative of welding progress, and determine whether each weld parameter satisfies a respective termination threshold indicative of a completed weld formed between the workpieces, and (iv) in response to determining that any one of the weld parameters satisfies a respective termination threshold prior to any other one of the weld parameters, initiate termination of the welding operation.

In some examples, one of the weld parameters corresponds to a welding time elapsed after initiation of the welding and another one of the weld parameters corresponds to a weld collapse distance between the workpieces.

According to some aspects, a method of ultrasonic welding in an automated mass production process includes: (a) advancing a pallet to a stop position adjacent an ultrasonic welding station, the ultrasonic welding station including a horn and a lift located below the horn, the lift and the horn defining a vertical axis, the pallet holding at least two parts to be welded together, the at least two parts being positioned along the vertical axis when the pallet is at the stop position, (b) moving, by the lift, the at least two parts from the pallet in an upward direction along the vertical axis, (c) while the lift is moving the at least two parts towards the horn, increasing an oscillating force of the horn, (d) while the lift is moving the at least two parts into contact with the horn, maintaining the oscillating force of the horn, and (e) maintaining the oscillating force of the horn at least until the lift retracts in a downward direction along the vertical axis to move the at least two parts away from the operating horn.

In some examples, the method includes engaging a floating nest with the lift; and engaging the at least two parts with the floating nest to move the at least two parts from the pallet.

In some examples, (b) occurs prior to (c).

In some examples, (b) and (c) occur simultaneously.

In some examples, the method includes decreasing a speed of movement along the vertical linear axis of the lift as the at least two parts approach the horn.

In some examples, decreasing a speed of movement along the vertical linear axis of the lift as the at least two parts approach the horn includes determining a distance between the at least two parts and the horn, and when the distance between the at least two parts and the horn is less than a predetermined lift distance, decreasing the speed of movement along the vertical linear axis of the lift.

In some examples, the ultrasonic welding station includes a linear displacement transducer for measuring the distance between the at least two parts and the horn.

In some examples, the method includes increasing the oscillating force of the horn when a force exerted against the at least two parts by the horn reaches a predetermined trigger force.

In some examples, increasing the oscillating force of the horn when a predetermined trigger force is reached includes determining the force exerted against the at least two parts by the horn, and when the force exerted on the at least two parts is greater than the predetermined trigger force, increasing the oscillating force of the horn.

In some examples, the method includes increasing the oscillating force of the horn for a predetermined time when the at least two parts are in contact with the horn, prior to maintaining the oscillating force of the horn.

In some examples, the method includes measuring a distance of collapse of the at least two parts and, when the distance of collapse reaches a predetermined collapse distance, maintaining the oscillating force of the horn.

In some examples, retracting the lift from the horn in (e) includes moving the lift away from the horn along the vertical linear axis.

In some examples, the method includes (f) after the lift is retracted from the horn, stopping the oscillating force of the horn and placing the at least two parts onto the pallet.

In some examples, the method includes repeating (a) to (f) for a plurality of subsequent parts on the pallet.

In some examples, the method includes (g), after (f), advancing the pallet from the stop position.

In some examples, the method includes repeating (a) to (g) for a plurality of subsequent pallets.

In some examples, the method includes carrying out (a) to (e) with a first pallet at a first ultrasonic welding station and carrying out (a) to (e) with a second pallet at a second ultrasonic welding station simultaneously.

In some examples, the method includes predicting defective welds of the at least two parts.

In some examples, predicting defective welds of the at least two parts includes determining a position of the at least two parts when the force of the horn begins to weld the at least two parts together, and in response to determining that the position of the at least two parts is outside of a predetermined range for the part position when welding, identifying the at least two parts as having a defective weld.

In some examples, predicting defective welds of the at least two parts includes determining a magnitude of the force applied to the at least two parts, and in response to determining that the magnitude of the force applied to the at least two parts is outside of a predetermined range, identifying the at least two parts as having a defective weld.

According to some aspects, an automated mass production system includes: (a) a plurality of pallets, each pallet holding at least two parts and advanceable through a stop position, (b) at least one ultrasonic welding station, each ultrasonic welding station of the at least one ultrasonic welding station including a horn and a lift located below the horn, the lift and the horn defining a vertical linear axis, an ultrasonic welding station of the at least one ultrasonic welding being adjacent the stop position, and (c) a control system for synchronizing operation of the pallets and the at least one ultrasonic welding station. The control system is configured to: (i) advance a pallet to the stop position, the at least two parts being positioned along the vertical axis when the pallet is at the stop position, (ii) move, by the lift, the at least two parts from the pallet in an upward direction along the vertical axis, (iii) while the lift is moving the at least two parts towards the horn, increase an oscillating force of the horn, (iv) while the lift is moving the at least two parts into contact with the horn, maintain the oscillating force of the horn, and (v) maintain the oscillating force of the horn at least until the lift retracts in a downward direction along the vertical axis to move the at least two parts away from the operating horn.

In some examples, the lift engages a floating nest and the floating nest engages the at least two parts to move the at least two parts from the pallet.

In some examples, (ii) occurs prior to (iii).

In some examples, (ii) and (iii) occur simultaneously.

In some examples, the control system is configured to decrease a speed of movement along the vertical linear axis of the lift as the at least two parts approach the horn.

In some examples, the control system is configured to determine a distance between the at least two parts and the horn, and when the distance between the at least two parts and the horn is of a predetermined lift distance, decrease the speed of movement along the vertical linear axis of the lift.

In some examples, the ultrasonic welding station includes a linear displacement transducer for measuring the distance between the at least two parts and the horn.

In some examples, the control system is configured to increase the oscillating force of the horn when a force exerted against the at least two parts by the horn reaches a predetermined trigger force.

In some examples, the control system is configured to determine the force exerted against the at least two parts by the horn, and when the force exerted on the at least two parts is greater than the predetermined trigger force, increasing the oscillating force of the horn.

In some examples, the control system is configured to increase the oscillating force of the horn for a predetermined time when the at least two parts are in contact with the horn prior to maintaining the oscillating force of the horn.

In some examples, the control system is configured to measure a distance of collapse of the at least two parts and, when the distance of collapse reaches a predetermined collapse distance, maintaining the oscillating force of the horn.

In some examples, the control system being configured to retract the lift from the horn in (v) includes the control system being configured to move the lift away from the horn along the vertical linear axis.

In some examples, the control system is configured to: (vi) after the lift is retracted from the horn, stop the oscillating force of the horn and place the at least two parts onto the pallet.

In some examples, the control system is configured to repeat (i) to (vi) for a plurality of subsequent parts on the pallet.

In some examples, the control system is configured to: (vii), after (vi), advance the pallet from the stop position.

In some examples, the control system is configured to repeat (i) to (vi) for a plurality of subsequent pallets.

In some examples, the at least one ultrasonic welding station includes at least a first welding station and a second welding station; the plurality of pallets includes at least a first pallet and a second pallet; and the control system is configured to carryout (i) to (v) with the first pallet at the first ultrasonic welding station and carryout (i) to (v) with the second pallet at the second ultrasonic welding station simultaneously.

In some examples, the control system is configured to predict defective welds of the at least two parts.

In some examples, the control system is configured to determine a position of the at least two parts when the force of the horn begins to weld the at least two parts together, and in response to determining that the position of the at least two parts is outside of a predetermined range for the part position when welding, identify the at least two parts as having a defective weld.

In some examples, the control system is configured to determine a magnitude of the force applied to the at least two parts, and in response to determining that the force applied to the at least two parts is outside of a predetermined range, identify the at least two parts as having a defective weld.

According to some aspects, a method of ultrasonic welding in an automated mass production process includes (a) advancing a pallet to a stop position adjacent an ultrasonic welding station, the ultrasonic welding station including a horn and a lift located below the horn, the lift and the horn defining a vertical axis, the pallet holding at least two parts to be welded together, the at least two parts being positioned along the vertical axis when the pallet is at the stop position, (b) electronically synchronizing the ultrasonic welding station to perform coordinated operations based on control parameters for the at least two parts, (c) moving, by the lift, the at least two parts from the pallet in an upward direction along the vertical axis, (d) while the lift is moving the at least two parts towards the horn and into contact with the horn, operating the horn to ultrasonically weld the at least two parts based on the control parameters, and (e) retracting the lift in a downward direction along the vertical axis based on the control parameters to move the at least two parts away from the operating horn.

According to some aspects, an automated mass production system includes (a) a plurality of pallets, each pallet holding at least two parts to be welded together and each pallet advanceable through a stop position, (b) at least one ultrasonic welding station, each ultrasonic welding station of the at least one ultrasonic welding station including a horn and a lift located below the horn, the lift and the horn defining a vertical axis, an ultrasonic welding station of the at least one ultrasonic welding station being adjacent the stop position, and (c) a control system for synchronizing operation of the pallets and the at least one ultrasonic welding station. The control system is configured to (i) advance a pallet to the stop position, the at least two parts being positioned along the vertical axis when the pallet is at the stop position, (ii) electronically synchronize the ultrasonic welding station to perform coordinated operations based on control parameters for the at least two parts, (iii) move, by the lift, the at least two parts from the pallet in an upward direction along the vertical axis, (iv) while the lift is moving the at least two parts towards the horn and into contact with the horn, operate the horn to ultrasonically weld the at least two parts based on the control parameters, and (v) retract the lift in a downward direction along the vertical axis based on the control parameters to move the at least two parts away from the operating horn.

According to some aspects, a method of ultrasonic welding in an automated mass production process includes (a) advancing a pallet to a stop position adjacent an ultrasonic welding station, the ultrasonic welding station including a horn and a lift located below the horn, the lift and the horn defining a vertical axis, the pallet holding at least two parts to be welded together, the at least two parts being positioned along the vertical axis when the pallet is at the stop position, (b) based on control parameters for the at least two parts, electronically synchronizing the ultrasonic welding station to (i) move, by the lift, the at least two parts from the pallet in an upward direction along the vertical axis and into contact with the horn (ii) operate the horn to ultrasonically weld the at least two parts, and (iii) maintain an oscillating force of the horn at least until the lift retracts in a downward direction along the vertical axis to move the at least two parts away from the operating horn.

In some examples, the method includes electronically synchronizing the ultrasonic welding station to decrease a speed of movement along the vertical linear axis of the lift as the at least two parts approach the horn based on the control parameters.

In some examples, the method includes electronically synchronizing the ultrasonic welding station to operate the horn to ultrasonically weld the at least two parts when a force exerted against the at least two parts by the horn reaches a predetermined trigger force.

According to some aspects, an automated mass production system includes (a) a plurality of pallets, each pallet holding at least two parts to be welded together and each pallet advanceable through a stop position, (b) at least one ultrasonic welding station, each ultrasonic welding station of the at least one ultrasonic welding station including a horn and a lift located below the horn, the lift and the horn defining a vertical axis, an ultrasonic welding station of the at least one ultrasonic welding station being adjacent the stop position, and (c) a control system for synchronizing operation of the pallets and the at least one ultrasonic welding station. The control system is configured to (i) advance a pallet to the stop position, the at least two parts being positioned along the vertical axis when the pallet is at the stop position (ii) based on control parameters for the at least two parts, electronically synchronize the ultrasonic welding station to (1) move, by the lift, the at least two parts from the pallet in an upward direction along the vertical axis and into contact with the horn, (2) operate the horn to ultrasonically weld the at least two parts, and (3) maintain an oscillating force of the horn at least until the lift retracts in a downward direction along the vertical axis to move the at least two parts away from the operating horn.

In some examples, the control system is configured to decrease a speed of movement along the vertical linear axis of the lift as the at least two parts approach the horn based on the control parameters.

In some examples, the control system is configured to operate the horn to ultrasonically weld the at least two parts when a force exerted against the at least two parts by the horn reaches a predetermined trigger force.

According to some aspects, a method of ultrasonic welding in an automated mass production process includes: (a) advancing a pallet to a stop position adjacent an ultrasonic welding station, the ultrasonic welding station including a horn and a lift located below the horn, the lift and the horn defining a vertical axis, the pallet holding at least two parts to be welded together, the at least two parts being positioned along the vertical axis when the pallet is at the stop position; (b) moving, by the lift, the at least two parts from the pallet in an upward direction along the vertical axis; (c) while the lift is moving the at least two parts towards the horn, increasing an oscillating force of the horn; and (d) based on control parameters for the at least two parts, electronically synchronizing the ultrasonic welding station to: (i) discontinue operating the horn; (ii) while an oscillating force of the horn is decreasing, maintain the lift in position to hold the at least two parts in contact with the horn; and (iii) retract the lift in a downward direction along the vertical axis to move the at least two parts away from the horn.

In some examples, the method includes electronically synchronizing the ultrasonic welding station to discontinue operating the horn when a distance of collapse of the at least two parts reaches a predetermined collapse distance.

In some examples, the lift is retracted in a downward direction along the vertical axis after the at least two parts are held in contact with the horn for a predetermined hold time.

According to some aspects, an automated mass production system includes: (a) a plurality of pallets, each pallet holding at least two parts to be welded together and each pallet advanceable through a stop position; (b) at least one ultrasonic welding station, each ultrasonic welding station of the at least one ultrasonic welding station including a horn and a lift located below the horn, the lift and the horn defining a vertical axis, an ultrasonic welding station of the at least one ultrasonic welding station being adjacent the stop position; and (c) a control system for synchronizing operation of the pallets and the at least one ultrasonic welding station. The control system is configured to: (i) advance a pallet to the stop position, the at least two parts being positioned along the vertical axis when the pallet is at the stop position; (ii) move, by the lift, the at least two parts from the pallet in an upward direction along the vertical axis; (iii) while the lift is moving the at least two parts towards the horn, increasing an oscillating force of the horn; and (iv) based on control parameters for the at least two parts, electronically synchronize the ultrasonic welding station to: (1) discontinue operating the horn; (2) while an oscillating force of the horn is decreasing, maintain the lift in position to hold the at least two parts in contact with the horn; and (3) retract the lift in a downward direction along the vertical axis to move the at least two parts away from the horn.

In some examples, the control system is configured to discontinue operating the horn when a distance of collapse of the at least two parts reaches a predetermined collapse distance.

In some examples, the control system is configured to retract the lift in a downward direction along the vertical axis after the at least two parts are held in contact with the horn for a predetermined hold time.

### BRIEF DESCRIPTION OF THE DRAWINGS

The drawings included herewith are for illustrating various examples of apparatuses, systems, and processes of the present specification and are not intended to limit the scope of what is taught in any way. In the drawings:

FIG. 1 is a schematic of an example automated mass production system;

FIG. 2 is a schematic of an example production device of the system of FIG. 1;

FIG. 3 is a schematic of an example implementation of the system 100 of FIG. 1;

FIG. 3A is a schematic of an example arrangement of a plurality of processing stations of the system of FIG. 1;

FIG. 4 is a perspective view of an example processing station of the system of FIG. 1;

FIGS. 5 to 9 are perspective views of the example processing station of FIG. 4 at different stages of a production process, and with a pallet portion of the station removed from FIGS. 7 and 8 to better show lift and horn portions of the station;

FIG. 10A is an example force curve of an ultrasonic weld performed by the processing station of FIG. 4;

FIG. 10B is an example force curve of a defective ultrasonic weld performed by the processing station of FIG. 4;

FIG. 11 is a flowchart illustrating a method of ultrasonic welding in an automated mass production process;

FIG. 12 is a flowchart illustrating another method of ultrasonic welding in an automated mass production process; and

FIG. 13 is a flowchart illustrating another method of ultrasonic welding.

### DETAILED DESCRIPTION

Various apparatuses, systems, or processes will be described below to provide an example of an embodiment of each claimed invention. No embodiment described below limits any claimed invention and any claimed invention may cover apparatuses, processes, or systems that differ from those described below. The claimed inventions are not limited to apparatuses, systems, or processes having all of the features of any one apparatus, system, or process described below or to features common to multiple or all of the apparatuses, systems, or processes described below. It is possible that an apparatus, system, or process described below is not an embodiment of any claimed invention. Any invention disclosed in an apparatus, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

A production process can involve processing (e.g. feeding, indexing, transferring, assembling, transporting, welding, validating, etc.) parts to produce a product. During the production process, parts requiring further processing (for example, subcomponents, assemblies, or partially finished products) can be referred to as workpieces. The workpieces can be moved through a production system among various production devices that operate on the workpiece(s) in production of the product.

In some applications, a production process can require welding of parts together, for example, in an ultrasonic welding operation of multiple parts According to some aspects of the present disclosure, a workpiece processing system can include a plurality of production devices electronically synchronized to improve efficiency of workpiece processing to facilitate ultrasonic welding of multiple workpieces in a continuous mass production process. According to some aspects, the production devices of the workpiece processing system can include one or more presentation devices (e.g. feed, indexing, and/or transport devices for feeding, preparing/assembling, and positioning parts for welding) and one or more processing devices (e.g. ultrasonic welding devices for performing ultrasonic welding on the parts) operable in electronic synchronization with one another to facilitate efficient workpiece processing. According to some aspects, the workpiece processing system can include a feed device for separating and delivering a leading workpiece from a stream of workpieces, an indexing device for receiving workpieces from the feed device and presenting the workpieces for processing, a pick-and-place robot for transferring the workpieces from the indexing device to another workpiece for assembly of the workpieces to form a set of workpieces for welding. The set of workpieces can be held by a transport device (e.g. in a nest of a pallet mounted to a carrier) movable along a track for transporting the workpiece from and/or to other production devices (e.g. to the ultrasonic welding station) for further processing. Operation of the feed device, indexing device, pick-and-place robot, carrier, and welding station can be electronically synchronized for improved efficiencies relative to some conventional workpiece processing systems.

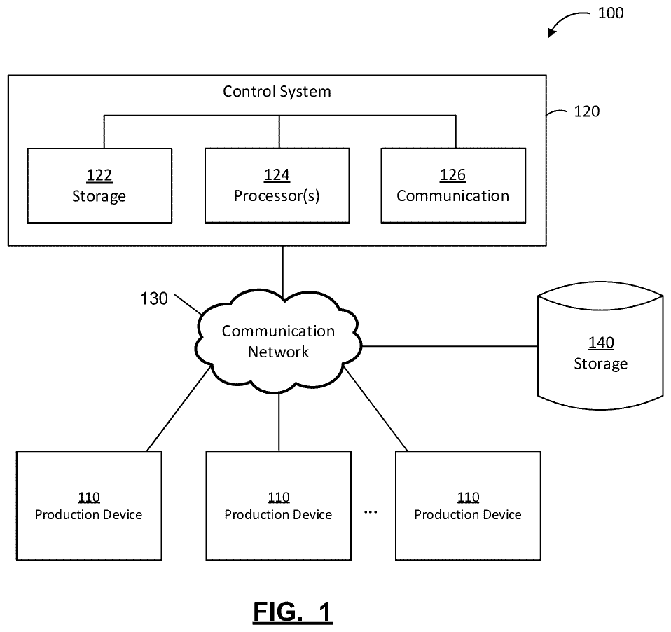

Referring to FIG. 1, a schematic of an example automated production system 100 is shown. In the example illustrated, the production system 100 includes a plurality of production devices 110 for processing workpieces, a production control system 120 for controlling operation of the production devices 110 and/or other system components to facilitate a mass production process, a communication network 130 for enabling communication among system components, and a production system storage component 140 for storing relevant data for the production system 100 (e.g. operational and/or control data relating to the production devices 110 and/or other aspects of the system 100).

In the example illustrated, the control system 120 includes a control system storage component 122, one or more system processors 124, and a system communication component 126. The system processor 124 controls operation of the control system 120. In some examples, the system processor 124 and processors at the production devices 110 cooperate to control operation of the system 100 (e.g. through determination and/or processing of control parameters and generation of control signals for operation and synchronization based on the control parameters).

In some examples, the storage component 122 (e.g. memory) can store data received from the production devices 110, data for coordinating operation of the production devices 110, property data in respect of each production device 110, etc. The storage component 122 can store computer programs executable by the system processor 124 to facilitate communication among and operation of the system components.

The production system storage component 140 can be accessible via the communication network 130 and provided in addition to or in lieu of the control system storage component 122. In some examples, the control system storage component 122 can store current operating data corresponding to current operation of the control system 120 (e.g. current position, speed, velocity, and/or acceleration of tooling), and the production system storage component 140 can store data for future use. In some examples, the storage component 140 can include third party data storage. The storage component 140 can store information about the production devices 110, including operating data, profile data (e.g., servo-motor profile data), motion data (e.g., tool motion data), part/workpiece/product data, etc. Such data can be stored in the storage component 140 for subsequent retrieval by the production devices 110 and/or control system 120, for example, through download via communication network 130.

The communication network 130 can carry data to enable communication among system components (e.g. among the control system 120, production devices 110, storage component 140, and/or other devices/components), and can be a wired and/or wireless communication network. In some examples, components of the system 100 (including, for example production devices 110 and control system 120) can include wireless communication interfaces to enable wireless communication through communication network 130.

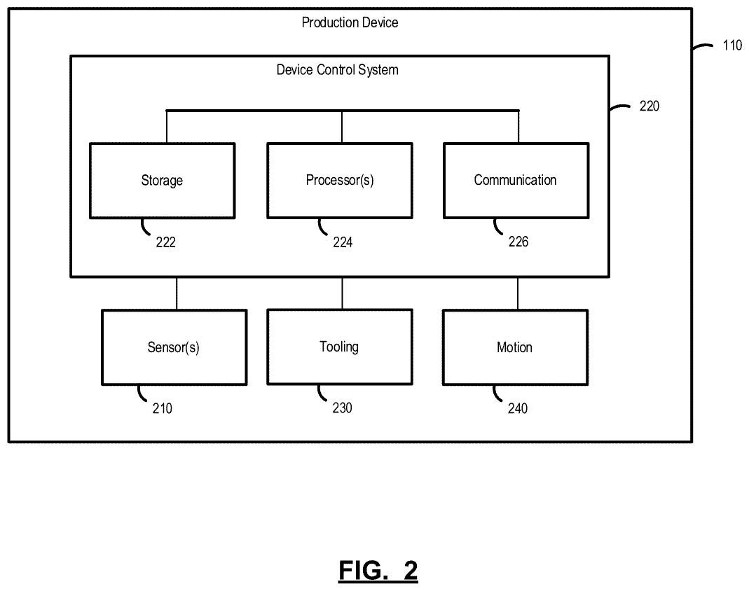

Referring to FIG. 2, a block diagram representing an example production device 110 is shown. In the example illustrated, the production device 110 includes a device control system 220, a sensor system 210, tooling 230, and a motion system 240.

In the example illustrated, the device control system 220 includes a device processor 224, a device storage component (e.g. memory) 222, and a device communication component 226. The device control system 220 is operable to control operation of the production device 110, and can collect and store sensor, tooling, and motion data for the production device 110 in the device storage component 222 for operational use and/or for providing to the control system 120 through network 130 to facilitate electronic synchronization of production devices 110.

The device storage component 222 can store data for operation of the production device 110 and/or to facilitate electronic synchronization. Example data can include, for example, operating data, part data, tool data, motion data, sensor data, etc. The sensor system 210 can include one or more sensors (e.g. range-finding, motion, vision systems, force sensors, displacement sensors, timers, etc.) for collecting operational and/or environmental data for facilitating the production process. Each production device 110 can be equipped with a motion system 240 for movement of the production device 110 and/or components thereof (e.g. sensors, tooling, etc.). The motion system 240 can include, for example, one or more servo-motors and/or other actuators.

The production devices 110 can be equipped with tooling 230 for engaging with and processing workpieces. Tooling 230 can be used for, for example, part handling, manipulation, assembly, transport, welding, etc. The operation of tooling 230 can be controlled by the device control system 220 based on, for example, sensor data from the sensor system 210 and operational data for the production device 110 or other production devices 110 and/or system components.

The tooling 230 can be in the form of, for example, one or more workpiece presentation tools for presenting the workpieces at predetermined locations for delivery and/or further processing (e.g. for receiving and assembling workpieces in a workpiece stack, and transporting and presenting the workpiece stack to an ultrasonic welding station for welding together the workpieces of the workpiece stack), and/or one or more workpiece processing tools for performing value-added operations on the workpieces (e.g. a sonotrode (horn) at the welding station for contacting and welding together the workpiece stack). The workpiece presentation tools can be part of, for example, one or more transports, carriers, conveyors, screws, indexer, actuators, pick-and-place robots, or other devices for, for example, separating a lead workpiece from other workpieces and delivery to another presentation and/or processing tool for subsequent processing. In some examples, the presentation tools can be part of a feed device and configured to, for example: load a workpiece at a delivery position at a leading end of a stream of like workpieces; separate the workpiece at the delivery position from the other workpieces; accelerate the workpiece; and deliver the workpiece at a predetermined delivery time, delivery position, delivery speed, and moving along a delivery trajectory. The workpiece presentation tool can be configured to deliver workpieces before loading one or more subsequent workpieces at the delivery position. In some examples, the workpiece presentation tools can be part of an indexing device and configured to, for example: receive one or more workpieces at a loading position (e.g. from a feed device); accelerate workpieces toward an unloading position; and present the workpieces at the unloading position for further processing. In some examples, the workpiece presentation tools can be part of a transport device and configured to, for example, receive one or more workpieces, accelerate the workpieces toward a stop position (e.g. along a transport track) for a processing station, and present the workpieces at the processing station for processing by a processing tool.

Processing tools can be configured to conduct one or more value-added operations on or with the workpieces. For example, the processing tools can be configured to manipulate a workpiece, assemble two or more workpieces together, reorient a workpiece for further processing, weld a set of workpieces together, etc. In some examples, processing tools can include, e.g. end effectors such as manipulators and/or grippers for part manipulation and/or assembly. In some examples, the processing tools can be part of a pick-and-place robot and can be configured to, for example, receive one or more workpieces from a workpiece presentation tool (e.g. of an indexing device); move the workpiece toward a processing position; and process the workpiece at the processing position (e.g. install the workpiece onto another workpiece presented adjacent the processing position, for example, by a transport device). In some examples, the processing tools can comprise a sonotrode (horn) and a lift for raising a set of assembled workpieces into contact with the sonotrode for ultrasonic welding of the workpieces.

Machine-readable instructions stored in storage component 222 (or in storage 122, 140) can cause the device control system 220 (and/or 120) to execute various methods disclosed herein including generation of one or more signals (e.g., output data) useful in operation of the production devices 110. Such machine-readable instructions can be incorporated into one or more computer program products which can be stored on suitable medium or media. In some embodiments, the machine-readable instructions can be executable by processor 224 and/or 124 for generation of signals useful in electronic synchronization of two or more operations carried out by the tooling 230 (e.g. by presentation and processing tools) of the production devices 110. The machine-readable instructions can be executable by the processor(s) for determination and/or selection of control parameters for operation of the tooling 230 and generate signals representative of the control parameters. For example, the machine-readable instructions can be configured to cause processor 224 and/or 124 to generate signals useful in the electronic synchronization of the delivery of workpieces by a workpiece presentation tool and receipt of the workpieces by a processing tool.

The synchronization of two or more operations performed by the tooling 230 of one or more production devices 110 can utilize electronic camming (e.g. instead of mechanical cams, gears, or linkages). In various embodiments, the use of such electronic synchronization can facilitate system flexibility and improve system performance relative to some more-conventional systems utilizing mechanical synchronization means. In some examples, storage component 222 (and/or 122, 140) can hold data representative of one or more cam profiles to be used in the operation of the tooling 230 of one or more production devices 110. For example, such cam profile(s) can be in tabular form and can include corresponding positions representative of synchronized trajectories to be followed by the tooling 230 during operation. In some examples, one tooling component 230 can be operated as a master device and another tooling component 230 can be operated as a slave device executing movements based on the execution of movements by the master device in order to substantially maintain synchronization between the slave device and the master device. In some examples, the production devices 110 can include one or more master devices and one or more respective slave devices. For example, multiple slave devices can be electronically cammed with a master device.

The machine-readable instructions can be configured to cause processor 224 and/or 124 to generate signals useful in electronic synchronization (e.g. camming) of the delivery of a workpiece by a presentation tool and of receipt of the workpiece by a processing tool (or another presentation tool). In some embodiments, the machine-readable instructions can be configured to cause the processor(s) to generate signals useful in electronic synchronization of loading, separation, acceleration, and delivery of a workpiece by a presentation tool and of receipt of the workpiece by a processing tool. In some examples, the machine-readable instructions can be configured to cause the processor(s) to generate signals useful in controlling movement of a workpiece along a delivery trajectory and controlling movement of a processing tool along a processing tool trajectory for electronic synchronization of the workpiece and processing tool.

In some examples, the machine-readable instructions can be configured to cause processor 224 and/or 124 to generate signals useful in controlling at least some aspect of the processing of a workpiece. For example, such processing can include one or more value-added operations that can be carried out by the processing tool. Such value-added operation can include, for example, assembly of two or more workpieces together through installation of one workpiece on another workpiece, and ultrasonic welding of the assembled workpieces. The machine-readable instructions can, for example, be configured to cause the processor(s) to generate signals useful in electronic synchronization of the processing of a workpiece and one or more operations associated with presentation and/or processing tools. In some examples, one or more operations conducted by the presentation or processing tools can be under binary control rather than direct electronic synchronization. In some examples, the triggering of an operation via a binary control signal can be dependent on the position of a master device and can still be based on a cam profile. The production devices 110 can include one or more servo-motors associated with tooling components 230, and the machine-readable instructions can be configured to cause processor 224 and/or 124 to generate signals useful in controlling the servo-motors according to a predetermined cam profile to carry out electronically synchronized operations according to the methods herein.

The production devices 110 can include a numerically synchronized control architecture. For example, transfer and presentation of workpieces (e.g. by presentation tools) according to the methods disclosed herein can include a first computer numerically controlled operation and the receiving of the workpiece (e.g. by a processing tool or another presentation tool) can include a second computer numerically controlled operation. In some examples, the loading, separating, accelerating, and delivering of workpieces can include a first computer numerically controlled operation and the receiving of the workpieces can include a second computer numerically controlled operation. In some examples, the receiving of a workpiece can include a first computer numerically controlled operation and the processing of the workpiece can include a second computer numerically controlled operation. In some examples, the presentation of a set of workpieces on a pallet at an ultrasonic welding station can include a first computer numerically controlled operation, and movement of the set of workpieces from the pallet and into contact with a horn at the ultrasonic welding station can include a second computer numerically controlled operation. In some examples, movement of the set of workpieces from the pallet and into contact with the horn at the ultrasonic welding station can include a first computer numerically controlled operation and ultrasonic welding of the set of workpieces through operation of the horn at the welding station can include a second computer numerically controlled operation. In some examples, ultrasonic welding of the set of workpieces at the welding station through operation of the horn can include a first computer numerically controlled operation and movement of the set of workpieces out of contact with the horn and back into the pallet can include a second computer numerically controlled operation. In such examples, the first computer numerically controlled operation and the second computer numerically controlled operation can be electronically synchronized (e.g. electronically cammed).

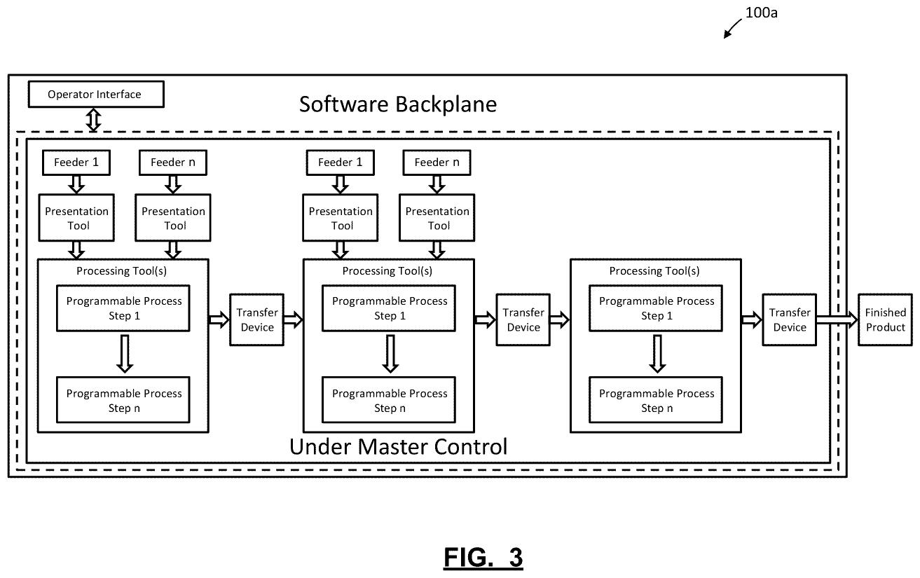

Referring to FIG. 3, an example implementation 100a of the system 100 is shown schematically. The example system 100a can be configured to carry out steps from processes disclosed herein. System 100a can receive workpieces and/or raw materials as inputs; progressively add value to them via processing tools (e.g. through assembly and welding of a set of workpieces); and discharge them either as discrete finished products, as unfinished products, or as rejected scrap (i.e., defective products).

As shown in FIG. 3, system 100a can receive the workpieces and/or materials from one or more feeders (e.g. of a feed device) for delivering workpieces and/or materials to another presentation tool (e.g. of an indexing device). The delivery from the feeders can be done directly or via a respective buffer. Each presentation tool or transfer device (e.g. workpiece carrier) of the system 100a can be numerically controlled and configured to deliver the materials and/or workpieces to one or more processing tools (e.g. of a processing device). Each processing tool can add value to a workpiece and/or material via one or more programmable process steps. A given processing tool can operate in parallel to and/or in series with one or more other processing tools and/or presentation tools. Once the workpiece passes through a final processing tool, it can be discharged either as a successfully completed and validated finished product, as an unfinished product, or as rejected scrap. Human interaction with system 100a can be through an operator interface.

The system 100a can include validation stations including validation devices configured to conduct inspections, checks, and/or tests on one or more of the workpieces. The validation stations can be located at, for example, one or more feeders, presentation tools, transfer devices, and/or processing tools. At these points, workpieces can be eliminated from the system as scrap if they do not meet one or more predetermined inspection criteria. Validation stations can be configured to conduct inspection, check, and/or test operations on one or more of workpieces that can be electronically synchronized with other devices, such as, for example, a master device of the production devices 110.

The various elements described above can be controlled at least in part by software resources known as base software backplane. The backplane can be configured to permit various elements of the system to carry out various control functions including: management of inputs and outputs; management of local control tasks, including programmable process steps within processing tools and local inspection tasks within validation stations; communications between different elements in the system and communication with a human user via the operator interface.

The system 100a can include a numerically synchronized control architecture. In various embodiments, the feeders, presentation tools, processing tools, transfer devices, lifts, and welding devices can be numerically controlled. Movement of workpieces and materials through the system can occur along programmable axes of motion, which can be either rotary or linear. Movement of tooling associated with the programmable process steps of processing tools can also take place along programmable linear and/or rotary axes of motion.

Referring to FIG. 3A, an example arrangement of production devices 110 of the system 100 is shown schematically. In the illustrated example, the system 100 can includes a transport track 150 supporting a plurality of carriers 152. Each carrier 152 comprises a pallet configured for holding one or more sets of workpieces 312. Each set of workpieces 312 can include at least two parts (workpieces) assembled (e.g. stacked or nested) together and having a joint interface at which the parts are weldable together. Each carrier 152 is moveable along the track 150 (e.g. through one or more servo-drives) among a plurality of processing stations 160. Each processing station 160 includes one or more production devices 110 operable in electronic synchronization with each other, the carriers 152, and/or production devices 110 of other processing stations 160 for processing the workpieces.

In the example illustrated, the processing stations 160 shown in FIG. 3A include at least one first processing station 160a for loading one or more sets of parts 312 into each carrier 152. The processing stations 160 further includes at least one second processing station 160b downstream of the first processing station 160a for ultrasonically welding together the parts in each set of parts 312. The processing stations 160 of the system 100 shown in FIG. 3A further include at least one third processing station 160c downstream of the second processing station 160b. Each third processing station 160c can be configured for further processing of the welded parts, for example, manipulating, validating, testing, inspecting (and/or performing some other operation), and/or for removing the ultrasonically welded parts from the carrier 152 for discharge from the system, either as a successfully completed and validated finished product, as an unfinished product, or as a rejected defective product. Validation, testing, and/or inspection of the welded parts can alternatively or additionally be performed at the second processing station 160b (e.g. at the ultrasonic welding station during and/or after the welding operation).

In the example illustrated, the system 100 as described above is configured for ultrasonic welding of a set of at least two workpieces 312, and the second processing station 160b can include an ultrasonic welding station for welding the at least two workpieces 312 together via an oscillating horn.

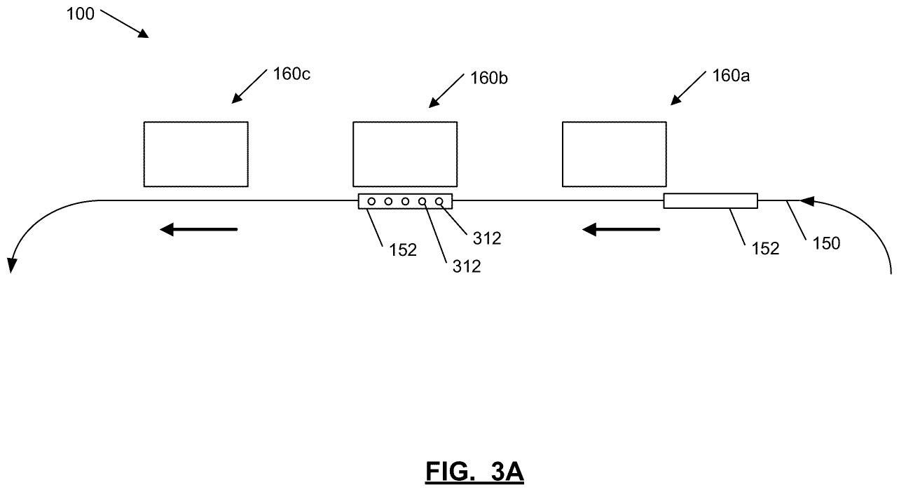

Referring now to FIG. 4, an example ultrasonic welding station 300 (e.g. for use as the second processing station in the system 100 as described above) is illustrated. The ultrasonic welding station 300 can include a plurality of production devices in electronic synchronization to facilitate efficient ultrasonic welding of the set of parts 312. In the example illustrated, the production devices 110 of the station 300 include a carrier comprising a pallet 302 for carrying a set of parts 312 to, and presenting the set of parts 312 at, a stop position. The pallet 302 can be a puck, or any other carrying method. In the example illustrated, the pallet 302 comprises nest tooling configured for holding a respective set of parts 312. In some embodiments, such as the example illustrated, the pallet 302 supports floating nest tooling 310. The set of parts 312 for welding can be carried by a respective floating nest tooling 310.

In some embodiments, the set of parts 312 can include at least two pieces of material for welding together. For example, in some embodiments, the set of parts 312 can include two parts assembled (e.g. in contact) together on the pallet 302. In some embodiments, the set of parts 312 can include more than two parts together on pallet 302. At least a portion of each part of the set of parts 312 can be in contact with another part of the set of parts at a joint interface configured to facilitate welding together of the set of parts 312. In some embodiments, the set of parts 312 can be stacked together on top of one another.

The production devices 110 at the ultrasonic welding station 160b can further include a sonotrode comprising a horn 306 energizable for transmitting vibrational energy to the set of parts for welding together the parts, and an actuator system comprising a lift 304 for transferring the set of parts 312 out from the pallet 302 and into contact with the horn 306 for welding. In the example illustrated, the lift 304 is in alignment with the stop position for lifting the set of parts 312 out of the pallet and toward the horn 306. The ultrasonic welding station 160b can further include a force sensor (e.g. transducer) 308 for measuring a contact force between the horn 306 and the set of parts 312 when brought into bearing engagement against the horn 306 by the lift 304.

The production devices 110 can be electronically synchronized to perform coordinated operations based on control parameters. The control parameters can be predetermined by a user of the system. In some embodiments, the control parameters can be selected based on properties of the set of parts 312 to be ultrasonically welded, such as, for example, type of material, size and/or shape of the parts and/or the joint interface between the parts, etc. In some embodiments, the amplitude and/or frequency of the vibrational energy (oscillating force) transmitted through the horn 306 can be controlled based on the control parameters. For example, the vibrational energy (oscillating force) transmitted through the horn 306 can be increased, maintained, or decreased based on the control parameters. The oscillating force of the horn 306 causes the horn 306 to move or swing back-and-forth. An increased oscillating force can increase the amplitude or frequency of oscillation (vibration) of the horn 306. In some embodiments, advancement and retraction of the lift 304 relative to the horn 306 can be controlled based on the control parameters.

The control parameters can facilitate the synchronized movement and/or operation of multiple production devices 110 at once. For example, in some examples, acceleration of the lift 304 upwardly toward the horn 306 can be initiated prior to arrival of the set of parts 312 at the stop position, so that the lift 304 is already moving toward the set of parts 312 as the set of parts 312 arrive at the stop position. In at least some embodiments, the lift 304 can move the set of parts 312 in an upward direction toward the horn while the horn is already energized and generating the vibrational energy for welding together the set of parts, and/or the oscillating force (vibrational energy) of the horn 306 can be increased as the set of parts 312 are moved toward the horn 306 by the lift 304.

In the example illustrated in FIG. 4, the control system 220 can advance each set of parts 312 in the pallet 302 to the stop position located adjacent the ultrasonic welding station 300 along the direction of arrow B shown in FIG. 4. In the example illustrated, the lift 304 is in alignment with the stop position. In the example illustrated, the lift 304 and the horn 306 are in alignment with the vertical axis A-A, and the stop position intersects the vertical axis A-A.

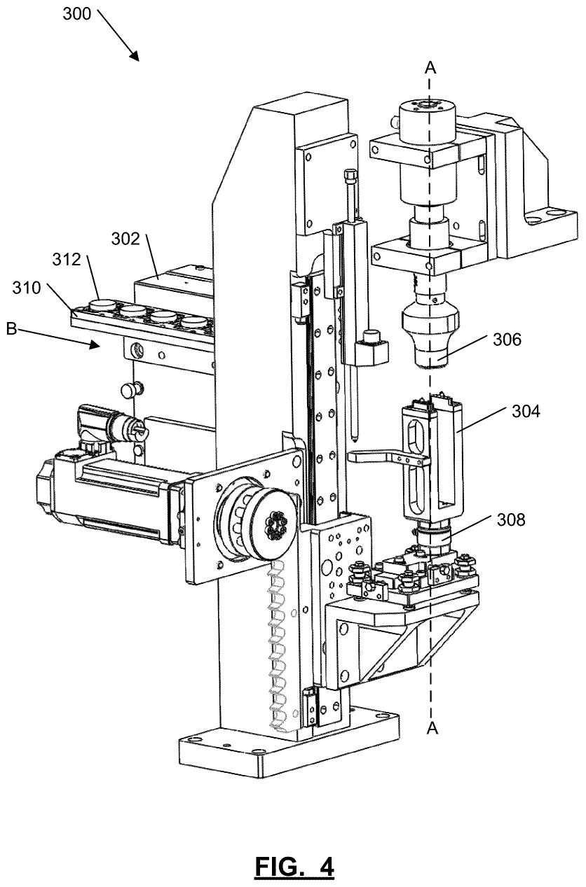

Referring to FIG. 5, in the example illustrated, the pallet 302 is shown located at the stop position adjacent to the ultrasonic welding station 300. Shown within the pallet 302 is a set of parts 312 for welding. The set of parts 312 is at the stop position and in alignment with the lift 304 and the horn 306. The set of parts 312 can remain located within the pallet 302.

In some embodiments, the control system 220 can advance the lift 304 upwardly toward the set of parts 312 along vertical axis A-A once the pallet 302 has been moved to position the set of parts at the stop position. In other embodiments, the control system 220 can advance the lift 304 upwardly along vertical axis A-A in electronic synchronization with the advancement of the set of parts 312 toward the stop position.

In the example illustrated, the control system 220 can move the lift 304 upwardly to engage the set of parts 312 within the pallet 302.

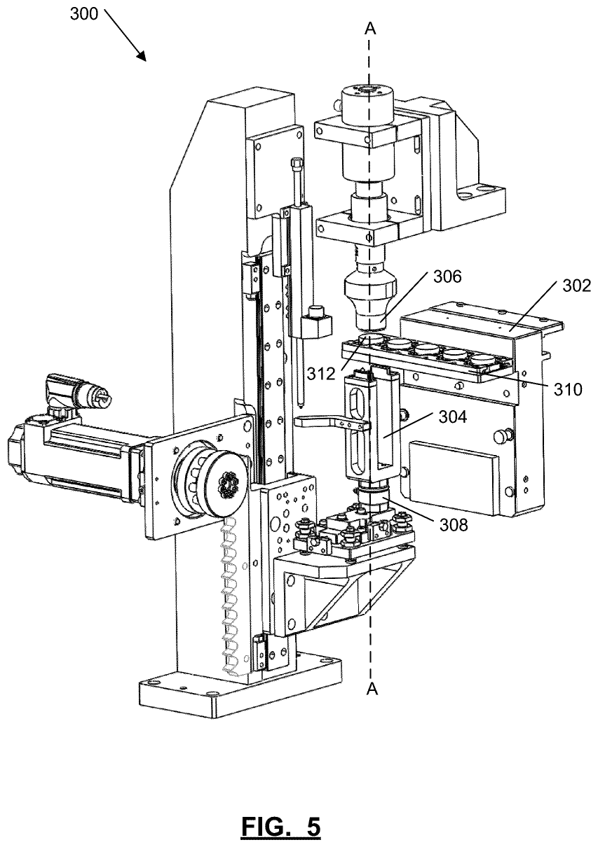

Referring now to FIG. 6, in the example illustrated, the control system 220 can operate the lift 304 to engage the set of parts 312 and move the set of parts 312 upwards along the vertical axis A-A. The lift 304, the horn 306, and the set of parts 312 at the stop position can be aligned with the vertical axis A-A.

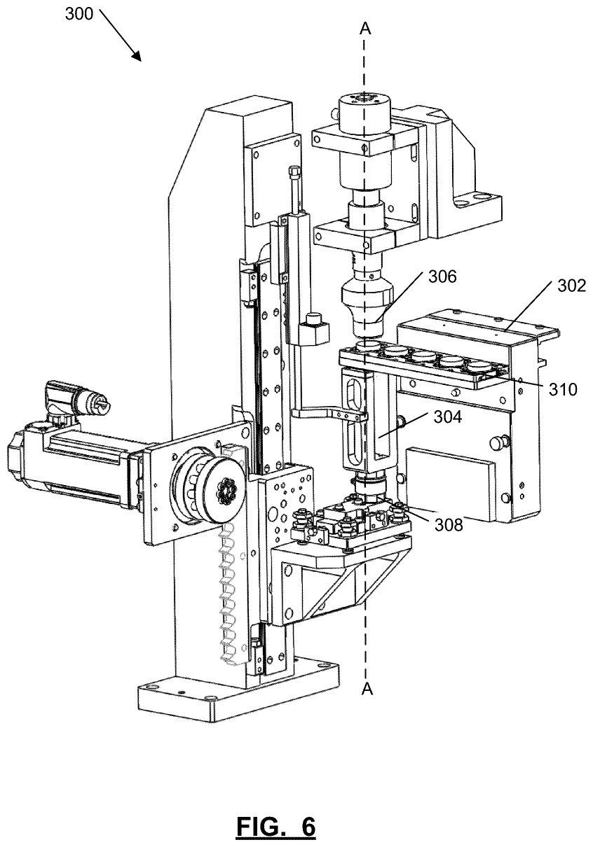

Referring now to FIG. 7, shown is a close-up view of the lift 304 in engagement with the set of parts 312. In some embodiments, as illustrated, the lift 304 can contact and lift out the floating nest tooling 310, which in turn supports the set of parts 312 to be welded. The floating nest tooling 310 can be used to reduce stress transfer between the set of parts 312 and the lift 304 and/or pallet, help prevent damage to the parts 312 when the lift raises the set of parts out from the pallet toward the horn and deposits the set of parts back into the pallet, and allow for increased upward and downward acceleration and speed of the lift 304 relative to systems without a floating nest configuration.

The station 300 can further includes a displacement sensor (e.g. transducer) 314 for measuring the linear displacement of the lift 304 relative to the horn 306 to determine positioning of the set of parts 312 relative to the horn 306. As shown in the example illustrated, lift 304 can also include an arm 318. Arm 318 can extend from lift 304 towards the body of the ultrasonic welding station 300. The arm 318 can be included with the ultrasonic welding station 300 to contact the linear displacement sensor (e.g. transducer) 314 of the ultrasonic welding station 300. The linear displacement transducer 314 can have a transducer probe 316 for contacting the arm 318 of the lift 304.

The linear displacement transducer 314 can be used to measure and control the distance between lift 304 and horn 306. The control system 220 can monitor the distance measurement to ensure that the set of parts 312 for welding does not contact the horn 306 prior to the predetermined optimal time or at an undesirable speed. The linear displacement transducer 314 can be further used to measure the relative displacement between the at least two parts 312. For example, during the weld, the two parts 312 can be compressed together by a weld collapse distance to complete the weld. The linear displacement transducer 314 can monitor the distance measurement between the two parts 312 being welded.

In some embodiments, the control system 220 can raise the lift 304, and thereby raise the set of parts 312 from the stop position adjacent to the ultrasonic welding station 300 towards the horn 306 for welding. When the arm 318 of the lift 304 contacts the linear displacement transducer 314 or the transducer probe 316, the linear displacement transducer 314 can determine a distance measurement of the set of parts 312 relative to the horn 306.

In some embodiments, the control system 220 can operate the lift 304 to accelerate the lift 304 to a first speed to raise the set of parts 312 to the horn 306. In said embodiment, the control system 220 can decelerate the lift 304 to a second speed that is slower than the first speed after a predetermined distance of travel. As the set of parts 312 move closer to the horn 306 during this stage, the control system 220 can further decelerate the lift 304 to allow the set of parts 312 to contact the horn 306 at a reduced speed.

In some embodiments, the control system 220 can decelerate the lift 304 from the first speed to the second, slower speed when the set of parts 312 is at a predetermined distance from the horn 306. In some embodiments, the control system 220 can decelerate the lift 304 from the first speed to the second, slower speed based on predetermined factors of the set of parts 312. In some embodiments, deceleration can be initiated to change the speed at a different distance based on the height of the set of parts 312. For example, a set of parts 312 with an increased height can result in the lift 304 starting to decelerate at a distance further from the horn 306, while a set of parts 312 with a deceased height can result in the lift 304 starting to decelerate at a distance closer to the horn 306.

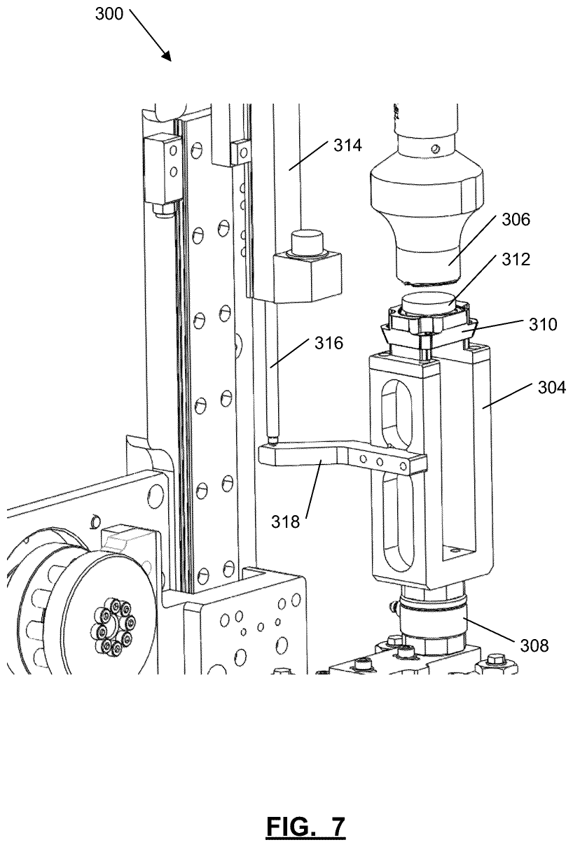

Referring now to FIG. 8, the control system 220 has moved the lift along vertical axis A-A to provide contact between the set of parts 312 and the horn 306. Once the horn 306 is in contact with set of parts 312 (e.g. with a top surface of an upper one of the parts 312), the control system 220 can begin to oscillate the horn 306 to weld the set of parts 312, generating and increasing the vibrational energy of the horn 306 once the horn 306 is in contact with the set of parts 312. Horn 306 can be of a variety of different shapes, which can be selected based on the properties (e.g. material, size, shape, joint interface, etc.) of the parts to be welded. In the illustrated embodiment, the ultrasonic welding station 300 also includes a force sensor (e.g. transducer) 308. In some embodiments, the force transducer 308 can be used to measure the pressure and/or compressive contact forces between the horn 306 and the set of parts 312 prior to, during, and/or after ultrasonic welding. The control system 220 can monitor this measurement and alter parameters of the ultrasonic welding operation (e.g. vibrational energy, lift position, etc.) based on predetermined factors, such as the type of parts 312, the material of the parts 312, previous failures of the weld, weld collapse, or any other factor that can impact the quality of the ultrasonic weld. In some examples, the contact force may be determined based on, for example, power being provided to the lift 304 for pressing the set of parts 312 against the horn 306 (which is fixed in the example illustrated).

In some embodiments, a piezoelectric sensor can be used to determine pressure and/or contact force between the set of parts 312 and the horn 306 (which can also be proportional to the contact force at the joint interface between the parts 312).

In some embodiments, the control system 220 can wait to power and begin to operate the horn 306 to oscillate until after the set of parts 312 has contacted horn 306. For example, energization of the horn 306 can be initiated to generate the vibrational energy after the set of parts 312 are in contact with horn 306. In other embodiments, the control system 220 can operate the horn 306 to oscillate prior to the set of parts 312 contacting horn 306. For example, the horn 306 can begin to oscillate when the lift 304 operates to bring the set of parts 312 to the horn 306. In such examples, energization of the horn 306 is initiated to generate the vibrational energy prior to contact of the horn with the set of parts 312, which can reduce cycle time in some examples (by not having to wait for the horn 306 to power up while in contact with the set of parts 312). In some embodiments, the oscillating force can be increased while the lift 304 moves the set of parts 312 closer to the horn 306 (i.e. by increasing energization of the horn). In some embodiments, the control system 220 can wait to begin to operate the horn 306 to oscillate after the pressure between the horn 306 and the set of parts 312 has built up to reach a predetermined pressure based on measurement taken by the force transducer 308.

In some embodiments, a contact force measurement is taken by the force transducer 308 of the ultrasonic welding station 300. For example, the force transducer 308 can indicate the contact force exerted on the set of parts 312 by horn 306 once the set of parts 312 and the horn 306 are in contact with one another. In some embodiments, the sensor can measure the contact force exerted against the set of parts 312 by the horn 306 to determine if the contact force corresponds to a trigger force.

The trigger force can be an indication that the set of parts 312 and the horn 306 are exerting sufficient force against one another to appropriately seat the set of part 312 together to facilitate welding. The trigger force can be predetermined by a user and/or can be based on properties of the joint interface between the parts (e.g. the required joint length).

In some embodiments, once the trigger force has been reached, the control system 220 can operate the horn 306 to begin oscillation (i.e. energize the horn 306 to generate the vibrational energy). In some embodiments, if the horn 306 is oscillating prior to the trigger force being reached, the control system 220 can increase oscillation of the horn 306 (i.e. increase energization of the horn 306 to increase the vibrational energy). In some embodiments, when the trigger force is reached, the control system 220 can steadily increase the oscillation frequency (and/or amplitude) of the horn 306 (i.e. increase the vibrational energy).

In some embodiments, when the trigger force has been reached, the control system 220 can operate the horn 306 to generally maintain the oscillating force (vibrational energy) of horn 306 while the part(s) 312 are being welded together. In some embodiments, the oscillating force can be maintained by the horn 306 until the lift 304 retracts the set of parts 312 from the horn 306, in which case the horn 306 remains energized while the set of parts 312 are moved out of contact with the horn to terminate the welding operation (which may help improve cycle time). In other examples, the horn 306 is de-energized to terminate the welding operation while the set of parts 312 remain in contact with the horn 306 under pressure to facilitate setting of the weld.

In some embodiments, during welding, the force measurement taken by the force transducer 308 can determine if the contact force corresponds to a melt force. The melt force can be an indication that the rate of the weld collapse of the set of parts 312 matches the melt flow of the joint being welded.

Once the melt force has been reached, the control system 220 can stabilize oscillation of the horn 306. For example, the control system 220 can continue operating the horn 306 to oscillate at the frequency and amplitude that the oscillation was occurring when the melt force was reached.

In some embodiments, the distance of the weld collapse is determined by a linear displacement transducer 314 at the ultrasonic welding station. The distance of the weld collapse can be determined by taking a point of reference when the set of parts 312 and the horn 306 first come into contact (or when the contact force corresponds to the trigger force). Once the weld collapse distance reaches a predetermined weld collapse distance from the point of reference, the weld collapse trigger can be satisfied.

The weld collapse trigger can indicate that the weld has completed. In some embodiments, the weld collapse trigger can be predetermined by a user, determined based on the type of weld, or determined based on the properties of the set of parts 312 (e.g. material, size, shape, joint interface, etc.). Once the weld collapse trigger has been reached, termination of the welding operation can be initiated. In other examples, termination of the welding operation can be initiated based on an elapsed time after initiation of the welding operation (e.g. after initiating transmission of the vibratory energy to the set of parts 312 in contact with the horn 306). In some examples, the horn 306 can be de-energized to stop oscillating to terminate the welding operation. In some embodiments, the horn 306 can continue to oscillate once the weld collapse trigger has been reached.

In some embodiments, once the weld of the set of parts 312 has completed, the control system 220 can operate the lift 304 to maintain, or hold the position of the set of parts 312 and the horn 306. That is, the control system 220 can maintain the set of parts 312 in contact with horn 306 for a predetermined length of time after the weld collapse trigger has been reached.

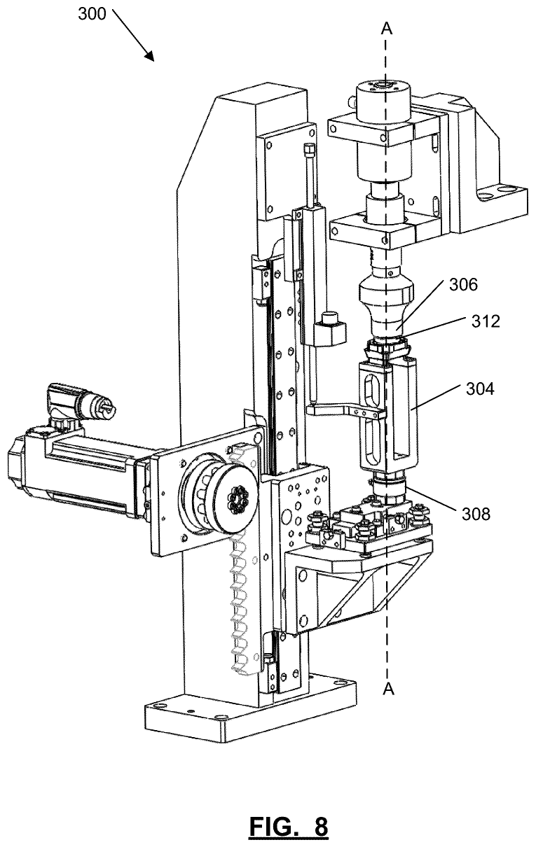

Referring now to FIG. 9, in the example illustrated, the control system 220 has moved the lift 304 vertically away from horn 306 along vertical axis A-A and returned the lift 304 to its initial (lowered) position. In some embodiments, the control system 220 can lower the lift 304 at any predetermined speed from the horn 306. In some embodiments, the control system 220 can lower the lift 304 at a speed faster than that of the first speed (i.e. for raising the lift 304 towards the horn 306). In some embodiments, the control system 220 can accelerate the lift 304 downwardly away from the horn 306 at an acceleration rate greater than the gravitational pull on the set of parts 312. In some embodiments, the lift 304 can include a part retention system comprising a vacuum to retain and keep the welded set of parts 312 vertically fixed relative to the lift 304, which can allow for increased acceleration of the lift 304 toward the lowered position while ensuring the set of parts 312 remain retained on and move with the lift 304 as it is accelerated downwardly away from the horn 306.

The control system 220 is configured to monitor the ultrasonic welding operation for assessing weld progress. In some examples, the control system 220 is configured to, during the welding, continuously monitor and assess a plurality of weld parameters (e.g. based on signals from a plurality of respective sensors). In some examples, each weld parameter is independently indicative of welding progress, and completion of a weld can be determined based on any one of the weld parameters independent of the other weld parameters. The plurality of weld parameters can comprise at least two different weld parameters, such as, for example, a welding time elapsed after initiation of the welding and a weld collapse distance between the workpieces; the welding time and a contact force between the horn and the set of workpieces; the weld collapse distance and the contact force; or the welding time, the weld collapse distance, and the contact force. The elapsed time can be monitored based on, for example, signals from a timer. The weld collapse distance can be monitored based on, for example, signals from the displacement sensor 314. The contact force can be monitored based on, for example, signals from the force sensor 308 (and/or power input to the lift).

In some examples, the control system 220 is further configured to continuously determine whether each weld parameter satisfies a respective termination threshold indicative of an acceptable completed weld formed between the workpieces. For example, for the elapsed time, the termination threshold can correspond to a predetermined elapsed time by which the weld should be completed. For the weld collapse distance, the termination threshold can correspond to a predetermined collapse distance at which the weld should be completed. For the contact force, the termination threshold can correspond to a predetermined force at which the weld should be completed.

In some examples, the control system 220 is further configured to, in response to determining that any one of the weld parameters satisfies a respective termination threshold prior to any other one of the weld parameters, initiate termination of the welding operation. Initiating termination of the welding can comprise, for example, de-energizing the horn 306 while the set of workpieces 312 remain in contact with the horn 306, or moving the set of workpieces 312 out of contact with the horn 306 (e.g. while the horn is still energized).

In one scenario, a first weld parameter can reach its respective termination threshold prior to a second weld parameter reaching its respective termination threshold. In this scenario, the control system terminates the welding operation when the first parameter reaches its respective termination threshold. In a second scenario, the second weld parameter can reach its respective termination threshold prior to the first weld parameter reaching its respective termination threshold. In this second scenario, the control system terminates the welding operation when the second parameter reaches its respective termination threshold. In some examples, the first weld parameter can correspond to the welding time and the second weld parameter can correspond to the weld collapse distance.

The type of workpieces, the welding station, the operational parameters, and the termination thresholds used for the first scenario may be generally identical to those used for the second scenario. However, due to minor variances among welding cycles in, for example, workpieces, joint interfaces, environmental conditions, and/or operating conditions, in some welding cycles, the first weld parameter may satisfy its termination threshold prior to the second weld parameter, and in other welding cycles the second weld parameter may satisfy its termination threshold prior to the first. The inventors determined that in some cases, terminating the welding operation based on any one of a plurality of the weld parameters satisfying its respective termination threshold prior to any other one of the weld parameters can improve weld consistency and overall quality for a batch of workpiece sets, relative to configuring the system to terminate welding based on the same single parameter (e.g. elapsed time or weld collapse distance) for a batch of identical workpiece sets.

In some embodiments, the control system 220 can monitor three or more weld parameters. For example, the control system 220 can terminate the welding operation when the earliest one of the three or more weld parameters (e.g. weld time, weld collapse distance, contact force) satisfies its respective termination threshold.

In some examples, each termination threshold can be set by an operator, for example, through experimentation, or through any other method of determining an appropriate termination threshold. In some embodiments, the termination threshold for each weld parameter can be determined based on an initial calibration process. The calibration process can include running a plurality of calibration weld cycles on a plurality of sample sets of identical parts over a range of each weld parameter to determine a suitable termination threshold to use for each of the weld parameters that results in acceptable (or optimum) weld quality for a batch of the sample sets.

In some examples, the control system 220 can terminate the welding operation when at least two of the three or more weld parameters each reach respective termination thresholds (e.g. both weld time and collapse distance termination thresholds are satisfied).

In some embodiments, the set of parts 312, after being welded, can be positioned back into the pallet 302 (e.g. through operation of the lift). The control system 220 can then advance the pallet 302 holding the set of parts 312 to move a subsequent set of parts 312 to the stop position in alignment with the vertical axis A-A, to another processing station, or to discharge the set of parts.

The ultrasonic welding station 300 can facilitate improved cycle time of the ultrasonic welding process. For example, the inclusion of linear displacement transducer 314 can allow for lift 304 to accelerate the set of parts 312 toward the horn 306 at a relatively high rate prior to contact with the horn 306. In some embodiments, the upward acceleration rate can be up to and in excess of gravitational acceleration (9.8 m/s²). Further, the acceleration of the lift 304 downwardly away from horn 306 after the weld is completed can be conducted at an acceleration rate greater than gravitational acceleration. Each of these examples can decrease the time required to complete a weld cycle for each set of parts 312.

In some embodiments, the ultrasonic welding station 300 can also include a failure detection system configured to detect failures in the ultrasonic welding process. For example, the ultrasonic welding station 300 can monitor various parameters of an ultrasonic weld process and predict whether the ultrasonic weld produced is defective.

In some embodiments, the control system of the ultrasonic welding station 300 can compare the monitored parameters of an ultrasonic weld with that of a typical non-defective weld. The control system can be configured to determine that the ultrasonic weld produced is defective in response to the monitored parameters being outside of a predetermined margin of error of the expected parameters of the typical non-defective ultrasonic weld. In some embodiments, the expected parameters of the typical non-defective ultrasonic weld can be identified using signature wave form analysis. Other methods of identifying a typical non-defective weld are possible. In some embodiments, a typical non-defective weld can be specific to the parts being welded.

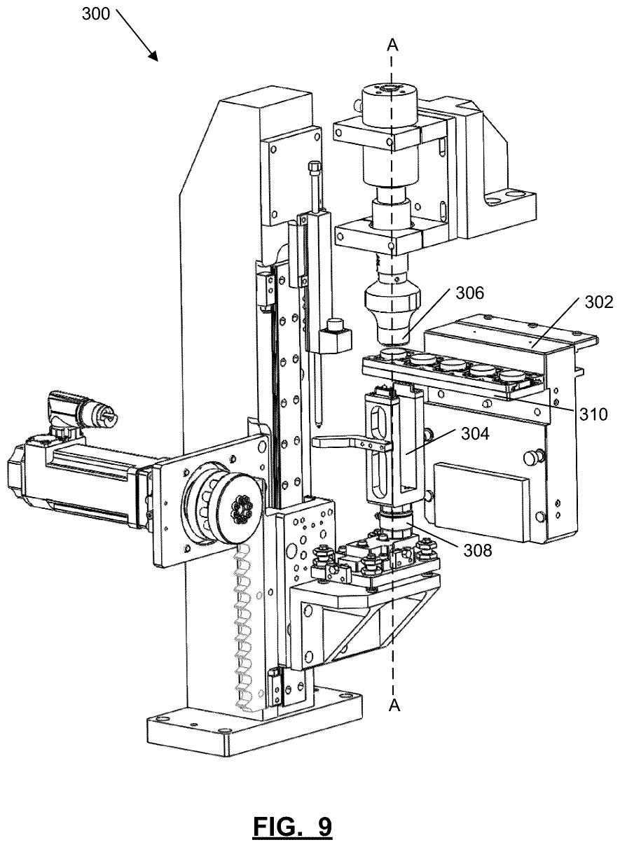

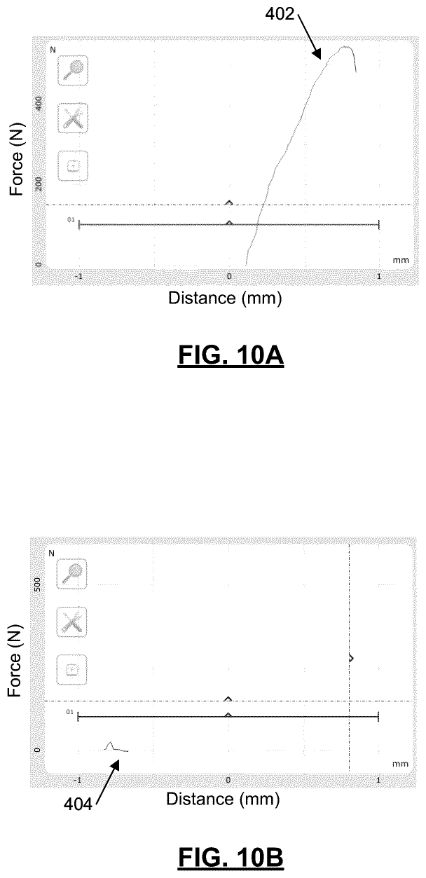

In some embodiments, a failure in the ultrasonic welding process can be determined based on the position of the set of parts 312 when the contact force increase begins. Reference is now made to FIGS. 10A and 10B, which are example graphs illustrating a contact force applied over a position of the set of parts (i.e., a force curve). FIG. 10A illustrates a force curve 402 of an example typical non-defective ultrasonic weld. As seen in FIG. 10A, one of the parts 312 can have a position of approximately 0.1 mm when the force increase begins to ultrasonically weld the set of parts 312. In comparison, FIG. 10B illustrates a force curve 404 of an example defective weld. As shown in FIG. 10B, a set of parts 312 having a position of approximately −0.16 mm when the force increase begins can be indicative of a defective weld. That is, the position of one of the parts 312 shown in FIG. 10B can be outside of a predetermined range for the part position when welding and the welded parts 312 can be identified as a defective weld. When the position of the parts 312 when the force increases is within the predetermined range for the part position when welding, the welded parts 312 would not be identified as a defective weld.

In some embodiments, a failure of the ultrasonic welding process can be determined based on a magnitude of the contact force applied to the set of parts 312. Returning now to FIG. 10A, the applied force of a typical non-defective ultrasonic weld can range between 0 N to 550 N. As shown in FIG. 10B, an applied force of approximately 50 N can be indicative of a defective weld. That is, a magnitude of the force applied to the set of parts 312 shown in FIG. 10B can be outside of the predetermined range for the magnitude of the applied force and the welded parts 312 can be identified as a defective weld. When the force applied to the set of parts 312 is within the predetermined range for the magnitude of the applied force, the welded parts 312 would not be identified as a defective weld.

In some embodiments, a failure of the ultrasonic welding process can be determined based on both the position of the set of parts 312 when the force begins to increase and the magnitude of the force applied to the set of parts 312. The welded parts 312 identified as having a defective weld may be rejected as a defective workpiece, subjected to further testing to confirm the defective weld, or subjected to other corrective actions.

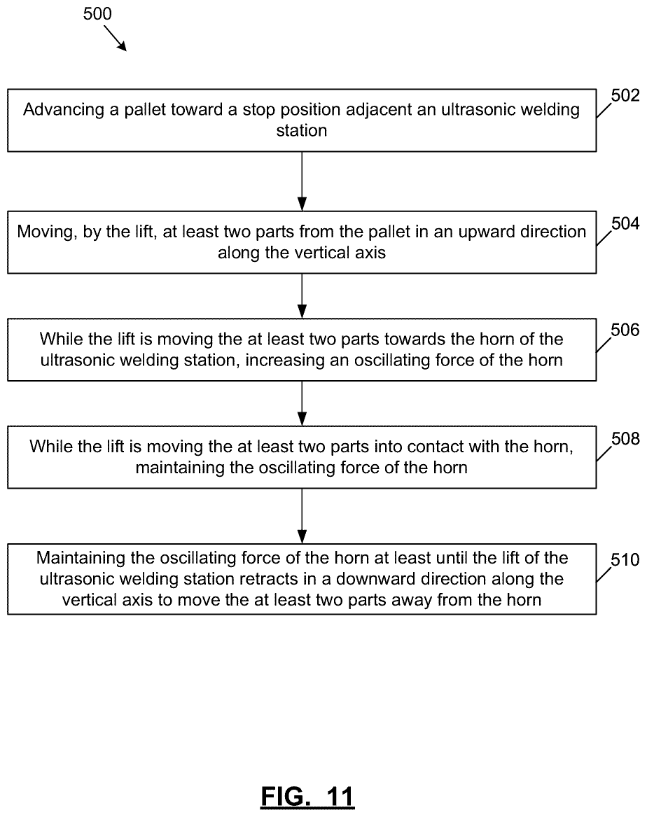

Referring to FIG. 11, shown therein is a flowchart illustrating a method 500 of ultrasonic welding using the ultrasonic welding station 300 in an automated mass production process.

At step 502, in the example illustrated in FIGS. 4 and 5, the pallet 302 is advanced to position the set of at least two parts 312 at the stop position adjacent the ultrasonic welding station 300.

At step 504, in the example illustrated in FIG. 6, the set of parts 312 are moved by the lift 304 from the pallet 302 in an upward direction along the vertical axis A-A. In some examples, the lift 304 can contact the set of parts 312 directly, and/or the lift 304 can contact the floating nest 310 holding the set of parts 312.

At step 506, in the example illustrated in FIGS. 6 and 7, the oscillating force of the horn 306 is increased. In some examples, the oscillating force of the horn 306 is increased while the lift 304 moves the set of parts 312 (while in the nest, in the example illustrated) towards the horn 306. In some embodiments, step 506 can occur after step 504. In some embodiments, step 506 can occur simultaneously with step 504.

In some embodiments, as the lift 304 moves the set of parts 312 in the upward direction along the vertical axis, a distance between the set of parts 312 and the horn 306 can be determined. When the distance between the set of parts 312 and the horn 306 is of a predetermined lift distance, the speed of movement along the vertical linear axis of the lift 304 can be decreased (i.e. deceleration of the lift 304 is initiated).

At step 508, in the example illustrated in FIG. 8, an upward force is applied along the vertical linear axis A-A to direct the set of parts 312 into forced contact with the horn 306, and the horn 306 oscillates to weld the set of parts 312 together.

In some embodiments, the contact force exerted against the set of parts 312 by the horn 306 can be determined. When the force exerted on the set of parts 312 reaches a predetermined trigger force, the oscillating force of the horn 306 can be increased. In some embodiments, the oscillating force of the horn 306 can be increased for a predetermined time when the set of parts 312 are in contact with the horn.

In some embodiments, a distance of weld collapse of the set of parts 312 can be measured. When the distance of weld collapse reaches a predetermined collapse distance, the oscillating force of the horn 306 can be maintained. That is, the oscillating force of the horn 306 is not further increased when the distance of weld collapse reaches the predetermined collapse distance.

At step 510, in the example illustrated in FIG. 9, the oscillating force of the horn 306 is maintained until at least the lift 304 retracts in a downward direction along the vertical axis A-A to move the set of parts 312 away from (and out of contact with) the horn 306. In some embodiments, retracting the lift 304 away from the horn 306 in step 510 can involve moving the lift 304 away from the horn 306 along the vertical linear axis A-A.

In some embodiments, the method can further involve, after the lift 304 has been retracted from horn 306, placing the set of parts 312 back onto the pallet 302. The set of parts 312 can be placed on the pallet 302, with or without the floating nest 310. The method can further involve advancing the pallet 302 to move the set of parts 312 away from the stop position.

The method can be repeated for a plurality of subsequent sets of parts 312. After each set of parts 312 from an initial pallet are welded and returned to the pallet, the initial pallet can be advanced away from the welding station and the method can be repeated for a plurality of subsequent pallets 302. The method can be further carried out on a second ultrasonic welding station simultaneously to the method being carried out on the ultrasonic welding station 300.

The process is repeated continuously for each set of parts 312 to complete ultrasonic welds on each set of parts 312 in a continuous mass production process. During advancement of a first pallet 302 to position a first set of parts 312 at the stop position, a second pallet can be advanced to position a second set of parts at a stop position for a second ultrasonic welding station. The method 500 can be repeated on the second ultrasonic welding station simultaneously to the method 500 on the ultrasonic welding station 300 to complete the weld of the set(s) of part on the second pallet.

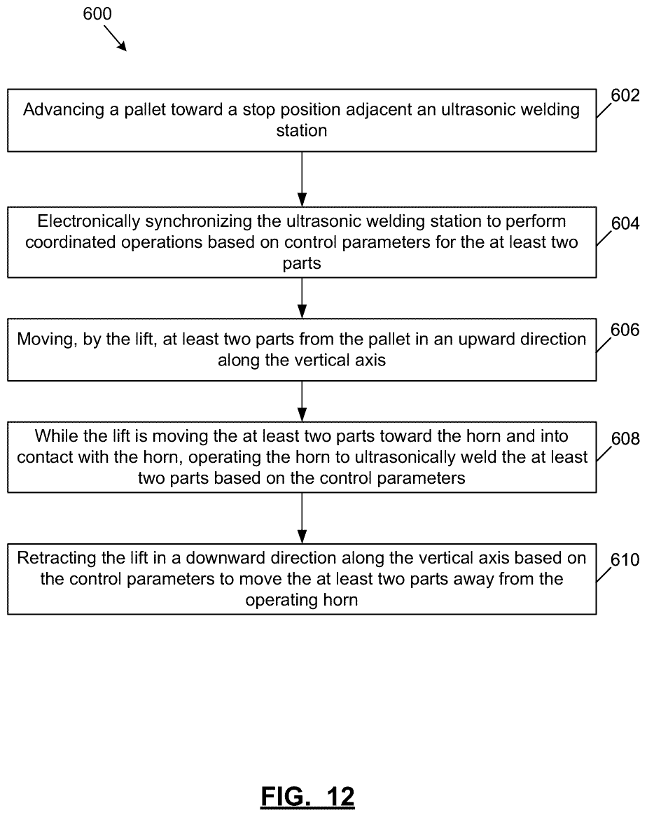

Referring to FIG. 12, shown therein is a flowchart illustrating another method 600 of ultrasonic welding using the ultrasonic welding station 300 in an automated mass production process.

At step 602, the pallet 302 is advanced to move the set of parts 312 to the stop position adjacent the ultrasonic welding station 300. Step 602 can be similar to step 502 of method 500.

At step 604, the ultrasonic welding station 300 is electronically synchronized to perform coordinated operations based on control parameters for the set of parts 312.

At step 606, the set of parts 312 are moved by the lift 304 from the pallet 302 in an upward direction along the vertical axis A-A. Step 606 can be similar to step 504 of method 500.

At step 608, the horn 306 can be operated for ultrasonically welding the set of parts 312 based on the control parameters. Step 608 can be initiated while the lift 304 is moving the at least two parts 312 towards the horn 306 and into contact with the horn 306.

At step 610, the lift 304 can be retracted in a downward direction along the vertical axis A-A based on the control parameters to move the at least two parts 312 away from the operating horn 306.

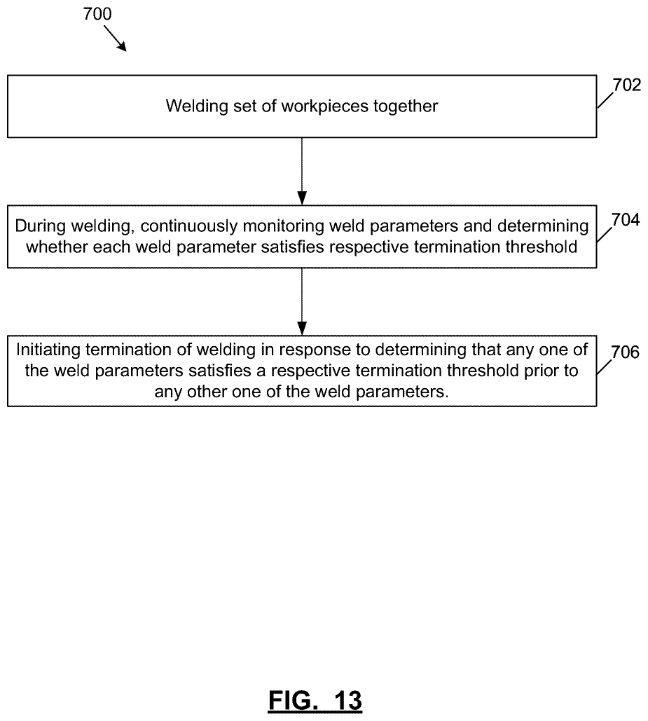

Referring to FIG. 13, shown therein is a flowchart illustrating a method 700 of ultrasonic welding. At step 702, the set of workpieces 312 are welded together by transmitting vibrational energy from the horn 306 to the set of workpieces 312 in a welding operation. At step 704, during the welding operation, the control system continuously: i) monitors the plurality of weld parameters (each indicative of welding progress), and (ii) determines whether each weld parameter satisfies a respective termination threshold indicative of a completed weld formed between the workpieces. At step 706, the control system initiates termination of the welding operation in response to any one of the weld parameters satisfying a respective termination threshold prior to any other one of the weld parameters.

1. A method of ultrasonic welding in an automated mass production process, comprising:
a) advancing a pallet to move a set of workpieces in the pallet into alignment with a lift of an ultrasonic welding station;
b) operating the lift to raise the set of workpieces out from the pallet and into contact with a horn of the ultrasonic welding station;
c) when the set of workpieces are in contact with the horn, transmitting vibrational energy from the horn to the set of workpieces to weld the workpieces together in a welding operation; and
d) after (c), operating the lift to lower the set of workpieces out of contact with the horn and back into the pallet.

2. The method of claim 1, wherein the set of workpieces are nested in a floating nest held by the pallet, and wherein (b) includes raising the lift to engage and raise the nest out from the pallet and toward the horn, and (d) includes lowering the lift to lower the nest back into the pallet and disengage the nest.

3. The method of claim 1, wherein during (b), the horn is energized to generate the vibrational energy prior to contact with the set of workpieces.

4. The method of claim 1, further comprising, during (b), increasing the vibrational energy prior to contact of the horn with the set of workpieces.

5. The method of claim 1, further comprising, during (c), increasing the vibrational energy.

6. The method of claim 1, wherein during (d), the horn remains energized while the set of workpieces is lowered out of contact with the horn.

7. The method of claim 1, further comprising, during (c), continuously: (i) monitoring a plurality of weld parameters, each weld parameter indicative of welding progress, and (ii) determining whether each weld parameter satisfies a respective termination threshold indicative of a completed weld formed between the workpieces.

8. The method of claim 7, further comprising, in response to determining that any one of the weld parameters satisfies a respective termination threshold prior to any other one of the weld parameters, initiating termination of the welding operation.

9. The method of claim 8, wherein initiating termination of the welding operation comprises one of: de-energizing the horn and lowering the set of workpieces out of contact with the horn.

10. The method of claim 8, wherein one of the weld parameters corresponds to a welding time elapsed after initiation of the welding operation and another one of the weld parameters corresponds to a weld collapse distance between the workpieces.

11. The method of claim 10, wherein another one of the weld parameters corresponds to a contact force between the horn and the set of workpieces.

12. The method of claim 1, wherein the pallet holds at least a first set of workpieces and a second set of workpieces, and the method includes, after performing (a) to (d) for the first set of workpieces, repeating (a) to (d) for the second set of workpieces in a continuous process.

13. The method of claim 12, further comprising, after (d) for the second set of workpieces, advancing the pallet away from the ultrasonic welding station for further processing of the first and second sets of workpieces, and advancing another pallet to position another set of workpieces for welding at the ultrasonic welding station.

14. An automated mass production system for ultrasonic welding of workpieces, comprising:
a) a plurality of pallets movably mounted to a track, each pallet carrying one or more sets of workpieces, each set of workpieces advanceable to a stop position along the track through movement of the pallet along the track;
b) at least one ultrasonic welding station adjacent the stop position, the ultrasonic welding station including a horn and a lift below the horn in alignment with the stop position, the lift vertically movable relative to the horn from a lowered position to a raised position for raising the set of workpieces at the stop position from the pallet and into contact with the horn, and from the raised position back to the lowered position for lowering the set of workpieces out of contact with the horn and back into the pallet; and
c) a control system configured to:
i) advance an initial pallet of the plurality of pallets along the track to move a respective set of workpieces in the pallet to the stop position;
ii) operate the lift to raise the set of workpieces at the stop position out from the pallet and into contact with the horn;
iii) when the set of workpieces are in contact with the horn, transmit vibrational energy from the horn to the set of workpieces to weld the workpieces together in a welding operation;
iv) after (iii), operate the lift to lower the set of workpieces out of contact with the horn and back into the pallet; and
v) after performing (i) to (iv) for each set of workpieces in the pallet, advancing the pallet along the track away from the ultrasonic welding station for further processing and repeating (i) to (v) for a subsequent pallet of the plurality of pallets.

15. The system of claim 14, wherein each set of workpieces is nested in a respective floating nest held by the pallet, and wherein the control system is configured to operate the lift to engage and raise the nest out from the pallet and toward the horn for (ii), and to lower the nest back into the pallet and disengage the nest for (iv).

16. The system of claim 14, wherein the control system is configured to energize the horn during (ii) to generate the vibrational energy prior to contact with the set of workpieces.

17. The system of claim 14, wherein the control system is configured to lower the set of workpieces out of contact with the horn while the horn remains energized.

18. The system of claim 14, wherein the control system is configured to, during (iii), continuously: monitor a plurality of weld parameters, each weld parameter indicative of welding progress; and determine whether each weld parameter satisfies a respective termination threshold indicative of a completed weld formed between the workpieces.

19. The system of claim 18, wherein the control system is configured to, in response to determining that any one of the weld parameters satisfies a respective termination threshold prior to any other one of the weld parameters, initiate termination of the welding operation.

20. The system of claim 19, wherein one of the weld parameters corresponds to a welding time elapsed after initiation of the welding and another one of the weld parameters corresponds to a weld collapse distance between the workpieces.
